(19) United States
(12) Patent Application Publication
(10) Pub. No.: US 2024/0079024 A1
(43) Pub. Date: Mar. 7, 2024

(54) COMMUNICATION SYSTEM FOR IMPROVING SPEECH

(71) Applicant: Tomato AI, Inc., Dancille, CA (US)

(72) Inventors: Ye JIA, Santa Clara, CA (US); James J. FAN, Mountain Lakes, NJ (US); Ofer RONEN, Danvile, CA (US)

(73) Assignee: Tomato AI, Inc., Danville, CA (US)

(21) Appl. No.: 18/460,642

(22) Filed: Sep. 4, 2023

Related U.S. Application Data
(60) Provisional application No. 63/466,771, filed on May 16, 2023.
(60) Provisional application No. 63/464,173, filed on May 4, 2023.
(60) Provisional application No. 63/461,309, filed on Apr. 23, 2023.
(60) Provisional application No. 63/374,553, filed on Sep. 4, 2022.

(51) Int. Cl. G10L 21/0364; G10L 15/07; G10L 15/16

(52) U.S. Cl. CPC G10L 21/0364; G10L 15/07; G10L 15/16

(57) ABSTRACT

The invention provides a communication system and method including a processor; a computer-readable medium connected to the processor, and a set of instructions on the computer-readable medium. A speech reception unit is executable by the processor to receive input speech in the form of an input signal derived from a sound wave generated by a microphone that includes input language. A speech processing system connected to the speech reception unit is executable by the processor to modify the input signal to an output signal wherein the input speech in the input signal is modified to output speech in the output signal. A speech output unit connected to the speech processing system is executable by the processor to provide an output of the output signal.

### CROSS-REFERENCE TO RELATED APPLICATIONS

This application claims priority from U.S. Provisional Patent Application No. 63/466,771, filed on May 16, 2023, U.S. Provisional Patent Application No. 63/464,173, filed on May 4, 2023, U.S. Provisional Patent Application No. 63/461,309, filed on Apr. 23, 2023, and U.S. Provisional Patent Application No. 63/374,553, filed on Sep. 4, 2022, all of which are incorporated herein by reference in their entirety.

### BACKGROUND OF THE INVENTION

### 1). Field of the Invention

This invention relates generally to a communication system and more specifically to a communication system for assisting with speech between two users.

### 2). Discussion of Related Art

The way that people express themselves through speech in a particular language, for example English, develops over time, often starting at a very young age. Regional, cultural, and other factors influence various characteristics of a language, for example regional accents, grammatical correctness or incorrectness, local terms or phrases, local or cultural pronunciations, profanities, or combinations thereof. These idiosyncrasies may result in difficulties for people to understand each other even though they are speaking in the same language, for example English. These challenges for people to understand each other have existed through history and have persisted with the advent of basic telephone systems that existed before the digitization of sound.

Several systems have taken advantage of the subsequent digitization of sound. For example, Voice-Over-Internet Protocol (VOIP) telephony systems allowed for digital packets to be transmitted instead of analog signals. Digitization has also allowed for inferences to be made and for words and phrases to be extracted from the sound. Such systems were integrated with translators that would provide textual translation of the language. It is also possible to convert the textual translation back to audio.

The digitization of sound has resulted in further challenges, in particular delays that are caused by jitter, latencies, or processes that have to be carried out, and/or remote server integration to carry out such processes.

### SUMMARY OF THE INVENTION

The invention provides a communication system including a processor, a computer-readable medium connected to the processor, and a set of instructions on the computer-readable medium. The set of instructions may include a speech reception unit executable by the processor to receive input speech in the form of an input signal derived from a sound wave generated by a microphone that includes input language, a speech processing system connected to the speech reception unit and executable by the processor to modify the input signal to an output signal wherein the input speech in the input signal is modified to output speech in the output signal, and a speech output unit connected to the speech processing system and executable by the processor to provide an output of the output signal.

The system may further include that the speech processing system includes a speech modification module executable by the processor to modify the input language in the input signal.

The system may further include that the speech modification module includes an intelligibility improvement engine having an accent conversion model, and an accent converter that modifies an accent in the input language based on the accent conversion model.

The system may further include that the accent converter retains a voice of the input speech.

The system may further include that the accent converter retains prosody of the input speech.

The system may further include that the accent conversion model includes an offline training model that generates a conversion relationship between a first accent of the language to a second accent of the language, and a streaming speech-to-speech model that converts from the first accent of the language to the second accent of the language based on the conversion relationship.

The system may further include that the accent conversion model has a first training structure of pairs of utterances and transcripts in the first accent, a second training structure of pairs of utterances and transcripts in the second accent and an input structure of pairs of utterances and transcripts in the first accent, wherein the offline training model trains on the first training structure and the second training structure based on input from the input structure to develop inferences to generate the conversion relationship.

The system may further include that the streaming speech-to-speech model has at least one neural network model to convert a spectrogram of the first accent to a spectrogram of the second accent.

The system may further include that the streaming speech-to-speech model has a plurality of neural network models to convert a spectrogram of the first accent to a spectrogram of the second accent.

The system may further include that the neural network models have different parameters for execution.

The system may further include that the neural network models function in series.

The system may further include that the at least one neural network model uses self-attention to model a sequence of input elements and a sequence of output elements by tracking relationships between pairs of the input elements.

The system may further include that the, for each output element, the self-attention looks at a subset of past input elements and a subset of future input elements.

The system may further include a relay server device positioned between first and second stacks of relays in a telephone system, the accent conversion model forming part of the relay server device.

The system may further include that the relay server device includes first and second codecs that connect the accent conversion device to the first and second stacks of relays respectively.

The system may further include that the accent conversion model is a first accent conversion model, further including a second accent conversion model that converts the second accent to the first accent, the second accent conversion model being connected to the first and second stacks of relays by the first and second codecs respectively.

The system may further include that the speech modification module includes an intelligibility improvement engine having at least a first knowledge base, and at least a first routine that modifies the input language based on the first knowledge base.

The system may further include that the first knowledge base includes a grammar knowledge base and the first routine is a grammar corrector.

The system may further include that the first knowledge base includes a localization knowledge base and the first routine is a localization subroutine.

The system may further include that the first knowledge base includes a pronunciation knowledge base and the first routine is a pronunciation correction engine.

The system may further include that the first knowledge base includes a profanity knowledge base and the first routine is a profanity correction engine.

The system may further include that the intelligibility improvement engine has at least a second knowledge base that is different from the first knowledge base, and at least a second routine that modifies the input language based on the second knowledge base.

The system may further include that the second knowledge base includes at least one of a grammar knowledge base, a localization knowledge base, a pronunciation knowledge base and a profanity knowledge base, and wherein the first knowledge base includes at least one of a grammar knowledge base, a localization knowledge base, a pronunciation knowledge base and a profanity knowledge base.

The system may further include that the speech modification module includes an audio receptor that receives the input language from the speech reception unit, a configurator that instructs the first and second routines to process the input language and a speech generator that generates the output speech after the input speech is processed by the first and second routines.

The system may further include that the speech modification module includes a listener profile database that holds a plurality of listener profiles, an audio receptor that receives the input language from the speech reception unit, a configurator that instructs the first routine to process the input language, wherein the first routine that modifies the input language based on the first knowledge base and based on a select one of the listener profiles, and a speech generator that generates the output speech after the input speech is processed by the first routine.

The system may further include that the configurator controls the audio receptor and the speech generator.

The system may further include that the first routine determines whether the listener profile includes senior citizen, retains a volume setting only if the user profile does not include senior citizen, and increases a volume setting only if the user profile does include senior citizen.

The system may further include that the first routine determines whether the listener profile includes a previous interaction, retains a volume setting only if the user profile does not include a previous interaction, and adjusts a volume setting to a previous setting only if the user profile does include a previous interaction.

The system may further include that the speech processing system includes a conversation management module having an overlap trigger to detect an overlap of input speech from first and second input signals, and a speaker suppressor connected to the overlap trigger to suppress the second speech in favor of not suppressing the first speech only when the overlap is detected and not when the overlap is not detected.

The system may further include that the overlap trigger detects the overlap of input speech from the first and second input signals by the detection of overlapping voice activities in a channel of first and second input signals.

The system may further include that the conversation management module further has a speaker selector that, based on a criteria, selects the second speech for suppression over the first speech.

The system may further include that the criteria determines that the speaker selector when selecting between the first and second speech always selects the second speech for suppression.

The system may further include that the criteria determines that the speaker selector when selecting between the first and second speech selects the first speech or the second speech for not suppression based on the first speech beginning before the second speech.

The system may further include that the speaker suppressor turns a volume of the second speech off.

The system may further include that the speaker suppressor turns a volume of the

The system may further include that the speech processing system includes a conversation management module executable by the processor and having a delay trigger that determines whether a gap between time segments in the input speech requires an injected utterance, and an utterance injector that merges an utterance with the time segments so that the utterance is between the time segments in the output speech.

The system may further include that the gap is for a period of time that is predictable based on a known process that is carried out to convert the input speech.

The system may further include that the known process is accent conversion.

The system may further include that the gap is for a period of time that is determined by implementing a machine learning based predictor using contextual features.

The system may further include that the contextual features include at least one of network speed, jitter, bandwidth, and prior latencies in transmission.

The system may further include that the conversation management module has an utterance selector that determines a type of utterance based on the contextual features.

The system may further include that the utterance is a sound made by a human.

The system may further include that the utterance is a background sound.

The system may further include that the contextual features are turns in a conversation.

The system may further include that the conversation management module has an utterance generator that generates utterances that are sent to the utterance selector.

The system may further include that the utterance generator generates utterances based on recordings from the speaker.

The system may further include that the utterance generator generates utterances based on synthesized utterances of the speaker.

The system may further include that the utterance generator generates utterances based on recordings of background noise from the speaker.

The system may further include that the utterance generator generates utterances based on an audio cue to suggest the incoming of an utterance.

The invention also provides a method of communicating including executing by a processor a speech reception unit to receive input speech in the form of an input signal derived from a sound wave generated by a microphone that includes input language, executing by the processor a speech processing system connected to the speech reception unit to modify the input signal to an output signal wherein the input speech in the input signal is modified to output speech in the output signal, and executing by the processor a speech output unit connected to the speech processing system to provide an output of the output signal.

The method may further include executing by the processor a speech modification module to modify the input language in the input signal.

The method may further include that the speech modification module includes an intelligibility improvement engine having an accent conversion model, and an accent converter that modifies an accent in the input language based on the accent conversion model.

The method may further include that the accent converter retains a voice of the input speech.

The method may further include that the accent converter retains prosody of the input speech.

The method may further include that the accent conversion model includes an offline training model that generates a conversion relationship between a first accent of the language to a second accent of the language, and a streaming speech-to-speech model that converts from the first accent of the language to the second accent of the language based on the conversion relationship.

The method may further include that the accent conversion model has a first training structure of pairs of utterances and transcripts in the first accent, a second training structure of pairs of utterances and transcripts in the second accent, and an input structure of pairs of utterances and transcripts in the first accent, wherein the offline training model trains on the first training structure and the second training structure based on input from the input structure to develop inferences to generate the conversion relationship.

The method may further include that the streaming speech-to-speech model has at least one neural network model to convert a spectrogram of the first accent to a spectrogram of the second accent.

The method may further include that the streaming speech-to-speech model has a plurality of neural network models to convert a spectrogram of the first accent to a spectrogram of the second accent.

The method may further include that the neural network models have different parameters for execution.

The method may further include that the neural network model function in series.

The method may further include that the at least one neural network model uses self-attention to model a sequence of input elements and a sequence of output elements by tracking relationships between pairs of the input elements.

The method may further include that the, for each output element, the self-attention looks at a subset of past input elements and a subset of future input elements.

The method may further include a relay server device positioned between first and second stacks of relays in a telephone system, the accent conversion model forming part of the relay server device.

The method may further include that the relay server device includes first and second codecs that connect the accent conversion device to the first and second stacks of relays respectively.

The method may further include that the accent conversion model is a first accent conversion model, further including a second accent conversion model that converts the second accent to the first accent, the second accent conversion model being connected to the first and second stacks of relays by the first and second codecs respectively.

The method may further include executing by the processor an intelligibility improvement engine having at least a first knowledge base, and at least a first routine that modifies the input language based on the first knowledge base.

The method may further include that the first knowledge base includes a grammar knowledge base and the first routine is a grammar corrector.

The method may further include that the first knowledge base includes a localization knowledge base and the first routine is a localization subroutine.

The method may further include that the first knowledge base includes a pronunciation knowledge base and the first routine is a pronunciation correction engine.

The method may further include that the first knowledge base includes a profanity knowledge base and the first routine is a profanity correction engine.

The method may further include that the intelligibility improvement engine has at least a second knowledge base that is different from the first knowledge base, and at least a second routine that modifies the input language based on the second knowledge base.

The method may further include that the second knowledge base includes at least one of a grammar knowledge base, a localization knowledge base, a pronunciation knowledge base and a profanity knowledge base, and wherein the first knowledge base includes at least one of a grammar knowledge base, a localization knowledge base, a pronunciation knowledge base and a profanity knowledge base.

The method may further include that the speech modification module includes an audio receptor that receives the input language from the speech reception unit, a configurator that instructs the first and second routines to process the input language, and a speech generator that generates the output speech after the input speech is processed by the first and second routines.

The method may further include that the speech modification module includes a listener profile database that holds a plurality of listener profiles, an audio receptor that receives the input language from the speech reception unit, a configurator that instructs the first routine to process the input language, wherein the first routine that modifies the input language based on the first knowledge base and based on a select one of the listener profiles, and a speech generator that generates the output speech after the input speech is processed by the first routine.

The method may further include that the configurator controls the audio receptor and the speech generator.

The method may further include that the first routine determines whether the listener profile includes senior citizen, retains a volume setting only if the user profile does not include senior citizen, and increases a volume setting only if the user profile does include senior citizen.

The method may further include that the first routine determines whether the listener profile includes a previous interaction retains a volume setting only if the user profile does not include a previous interaction, and adjusts a volume setting to a previous setting only if the user profile does include a previous interaction.

The method may further include that the executing the speech processing system includes executing a conversation management module executable by the processor and having an overlap trigger to detect an overlap of input speech from first and second input signals, and a speaker suppressor connected to the overlap trigger to suppress the second speech in favor of not suppressing the first speech only when the overlap is detected and not when the overlap is not detected.

The method may further include that the overlap trigger detects the overlap of input speech from the first and second input signals by the detection of overlapping voice activities in a channel of first and second input signals.

The method may further include that the conversation management module further has a speaker selector that, based on a criteria, selects the second speech for suppression over the first speech.

The method may further include that the criteria determines that the speaker selector when selecting between the first and second speech always selects the second speech for suppression.

The method may further include that the criteria determines that the speaker selector when selecting between the first and second speech selects the first speech or the second speech for not suppression based on the first speech beginning before the second speech.

The method may further include that the speaker suppressor turns a volume of the second speech off.

The method may further include that the speaker suppressor turns a volume of the second speech down.

The method may further include that the executing the speech processing system includes executing a conversation management module executable by the processor and having a delay trigger that determines whether a gap between time segments in the input speech requires an injected utterance, and an utterance injector that merges an utterance with the time segments so that the utterance is between the time segments in the output speech.

The method may further include that the gap is for a period of time that is predictable based on a known process that is carried out to convert the input speech.

The method may further include that the known process is accent conversion.

The method may further include that the gap is for a period of time that is determined by implementing a machine learning based predictor using contextual features.

The method may further include that the contextual features include at least one of network speed, jitter, bandwidth, and prior latencies in transmission.

The method may further include that the conversation management module has an utterance selector that determined a type of utterance based on the contextual features.

The method may further include that the utterance is a sound made by a human.

The method may further include that the utterance is a background sound.

The method may further include that the contextual features are turns in a conversation.

The method may further include that the conversation management module has an utterance generator that generates utterances that are sent to the utterance selector.

The method may further include that the utterance generator generates utterances based on recordings from the speaker.

The method may further include that the utterance generator generates utterances based on synthesized utterances of the speaker.

The method may further include that the utterance generator generates utterances based on based on recordings of the background noise from the speaker. The method may further include that the utterance generator generates utterances based on an audio cue to suggest the incoming of an utterance

### BRIEF DESCRIPTION OF THE DRAWINGS

The invention is further described by way of examples with reference to the accompanying drawings, wherein:

FIG. 1 is a block diagram of a communication system according to an embodiment of the invention;

FIG. 2 is a flow chart illustrating the functioning of an intelligibility improvement engine of the communication system;

FIG. 3 is a flow chart illustrating the functioning of the intelligibility improvement engine;

FIG. 4 is an illustrative diagram illustrating functioning of a conversation management module of the communication system;

FIG. 5 is a time chart illustrating speaker suppression of the conversation management module;

FIG. 6 is an illustrative block diagram illustrating utterance injection of the conversation management module;

FIG. 7 is a time chart illustrating utterance injection of the conversation management module;

FIG. 8 is a block diagram illustrating an offline accent training model and a training speech-to-speech model of an accent converter forming part of the intelligibility improvement engine;

FIG. 9 illustrates details of the streaming speech-to-speech model, including a plurality of transformers;

FIG. 10 is a time chart showing functioning of one of the transformers;

FIG. 11 is a block diagram illustrating deployment of accent conversion on a user device;

FIG. 12 is a block diagram illustrating deployment of accent conversion on a server device;

FIG. 13 is a block diagram illustrating deployment on a user device and on a server device;

FIG. 14 is a is a block diagram illustrating deployment of accent conversion within a telephony system; and

FIG. 15 is a block diagram of a machine in the form of a computer that can find application in the present invention system, in accordance with one embodiment of the invention.

### DETAILED DESCRIPTION OF THE INVENTION

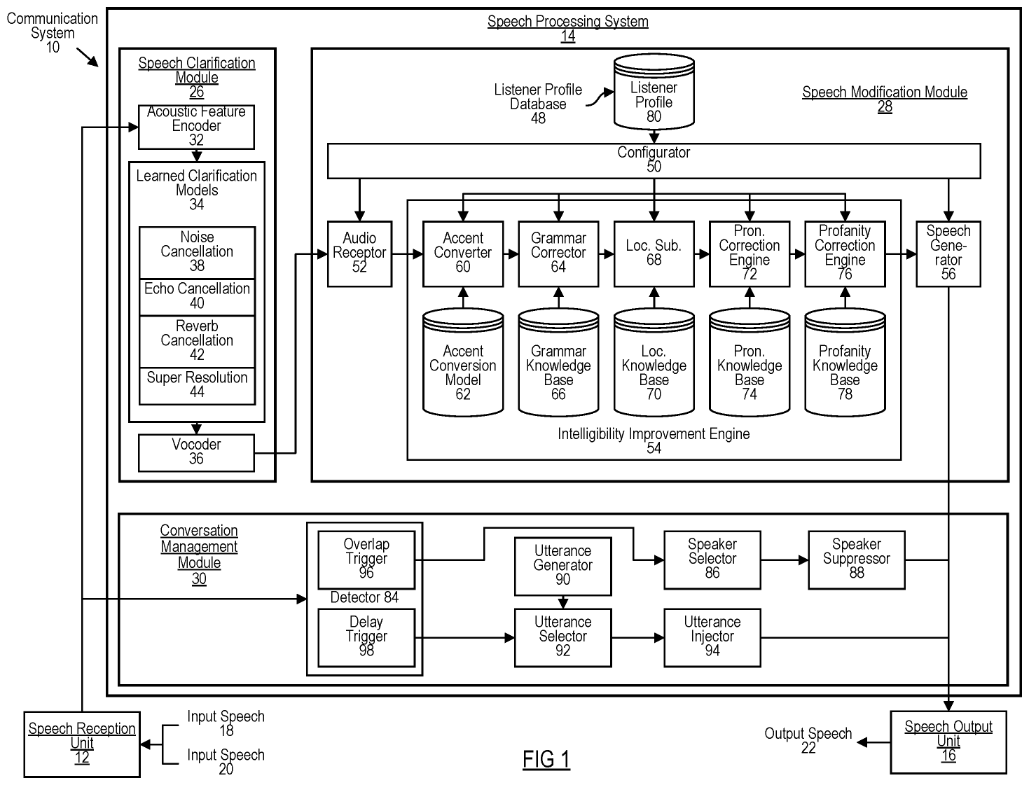

FIG. 1 of the accompanying drawings illustrates a communication system 10, according to an embodiment of the invention. The communication system 10 includes a processor (not shown), a computer-readable medium (not shown) connected to the processor, and a set of instructions on the computer-readable medium. The set of instructions include a speech reception unit 12, a speech processing system 14, and a speech output unit 16 that are executable by the processor.

The speech reception unit 12 receives input speech 18 and 20 from first and second users respectively. Each user has a microphone that converts a sound wave created by the user into a signal. The sound wave includes input language, such as spoken English, spoken Polish, or spoken German, and the input language may be in a particular accent of the user, such as Indian English or American English. The input speech 18 or 20 received by the speech reception unit 12 is thus in the form of an input signal derived from a sound wave generated by a microphone that includes the input language.

The speech processing system 14 is connected to the speech reception unit 12. The speech processing system 14 modifies the input signal to an output signal. The input speech 18 or 20 in the input signal is modified to output speech 22 in the output signal.

The speech output unit 16 is connected to the speech processing system 14. The speech output unit 16 provides an output of the output signal, which includes the output speech 22.

The speech processing system 14 includes a speech clarification module 26, a speech modification module 28, and a conversation management module 30. The speech clarification module 26 and the conversation management module 30 are connected in parallel to the speech reception unit 12. The speech modification module 28 is connected in series after the speech clarification module 26. The speech output unit 16 is connected in series after the speech modification module 28 and the conversation management module 30.

The speech clarification module 26 includes an acoustic feature encoder 32, learned clarification models 34, and a vocoder 36 that are connected sequentially after one another. The acoustic feature encoder 32 detects acoustic features that may require further clarification. The learned clarification models 34 include clarification models for noise cancellation 38, echo cancellation 40, reverb cancellation 42, and super resolution 44. The learned clarification models 34 are known to ones skilled in the art and are beyond the scope of the invention.

The vocoder 36 performs speech coding that analyzes and synthesizes the human voice signal for audio data compression, multiplexing, voice encryption, or voice transformation. The vocoder 36 examines speech by measuring how its spectral characteristics change over time. The result is a series of signals representing the frequencies at any particular time that the user speaks and are represented in a “spectrogram”. The signal is split into a number of frequency bands and the level of the signal represented at each frequency band gives the instantaneous representation of the spectral energy content.

The speech modification module 28 modifies the input language in the input signal, i.e., the input language in the input speech 18 or 20, after the speech is clarified by the speech clarification module 26. The speech modification module 28 includes a listener profile database 48, a configurator 50, an audio reception 52, an intelligibility improvement engine 54, and a speech generator 56. The configurator 50 serves as a central controller and the listener profile database 48, audio receptor 52, intelligibility improvement engine 54, and speech generator 56 are connected to the configurator 50. Any sequencing of processes within the speech modification module 28 are orchestrated by instructions from the configurator 50.

The audio receptor 52 is connected to the vocoder 36 to receive the input speech 18 and 20 from the vocoder 36. The audio receptor 52 thus receives the input language that is in the input speech 18 and 20 via the speech reception unit 12 and the speech clarification module 26. The configurator 50 controls the reception of the input language by the audio receptor 52 and causes the audio receptor 52 to pass the input speech 18 and 20 together with the language embedded therein to the intelligibility improvement engine 54.

The intelligibility improvement engine 54 includes an accent converter 60 with an associated accent conversion model 62 connected thereto, a grammar corrector 64 with an associated grammar knowledge base 66 connected thereto, a localization subroutine 68 with an associated localization knowledge base 70 associated therewith, a pronunciation correction engine 72 with a pronunciation knowledge base 74 associated therewith, and a profanity correction engine 76 with a profanity knowledge base 78 associated therewith. The accent converter 60, grammar corrector 64, localization subroutines 68, pronunciation correction engine 72, and profanity correction engine 76 are connected to one another in series.

In use, the accent converter 60 receives the speech from the audio receptor 52 and converts the accent from a first accent to a second accent. The accent converter 60 converts the accent based on the accent conversion model 62. The accent converter 60 converts the accent based on listener profile 80 held within the listener profile database 48. For example, the accent converter 60 may convert the accent from an Indian English accent to an American English accent because the listener profile 80 for a particular listener suggests that the listener is an American citizen.

The accent conversion model 62 has the ability to preserve the voice of the speaker in the input speech 18 or 20. The accent conversion model 62 may for example determine a timbre of the voice based on a fundamental frequency and harmonics and how they related to one another in the particular user's voice. To retain the voice, the timbre may be retained.

Details of how a voice can be retained while modifying speech can be found in Zhou, Yi & Wu, Zhizheng & Zhang, Mingyang & Tian, Xiaohai & Li, Haizhou. (December 2022). TTS-Guided Training for Accent Conversion Without Parallel Data. 10.48550/arXiv.2212.10204.

The accent conversion model 62 has the ability to tune the voice of the speaker in the input speech 18 or 20 so that a voice in the output speech 22 is different. The accent conversion model 62 may for example determine a timbre of the voice based on a fundamental frequency and harmonics and how they related to one another in the particular user's voice. To tune the voice, the timbre may be modified.

The accent conversion model 62 also retains prosody of the speech, in particular, the timing and rhythm of the speech.

The grammar corrector 64 receives the accent-corrected speech from the accent convertor 60 and performs a grammar correction the input language. Although grammar is more universal across cultures than accents, certain differences still exist. The grammar corrector 64 relies on the grammar knowledge base 66 for the grammar correction and the grammar correction is done based on the same listener profile 80 in the listener profile database 48. Following the grammar corrector 64, the language is subsequently processed by the localization subroutine 68, pronunciation correction engine 72 and the profanity correction engine 76. In each case, a respective knowledge base 70, 74, or 78 informs the respective subroutine or engine 68, 72 or 76 based on the particular listener profile 80 in the listener profile database 48.

Following processing of the input language by the profanity correction engine 76, the configurator 50 instructs the profanity correction engine 76 to pass the speech to the speech generator 56. The speech generator 56 then turns the speech into an audio signal and passes the audio signal on to the speech output unit 16.

The conversation management module 30 includes a detector 84, a speaker selector 86, a speaker suppressor 88, an utterance generator 90, an utterance selector 92, and an utterance injector 94. The detector 84 has an overlap trigger 96 and a delay trigger 98. The detector 84 is connected to the speech reception unit 12. The overlap trigger 96, speaker selector 86 and speaker suppressor 88 are sequentially connected to one another. The delay trigger 98, utterance selector 92 and utterance injector 94 are sequentially connected to one another. The utterance generator 90 is connected to the utterance selector 92. The speaker suppressor 88 and utterance injector 94 are connected to the speech output unit 16.

The overlap trigger 96 detects an overlap of the input speech 18 and 20. The first and second input signals may for example indicate that the first and second users are simultaneously creating speech. For example, the overlap trigger 96 may detect an overlap of input speech from the first and second input signals by the detection of overlapping voice activities in channels of first and second input signals.

The speaker selector 86 selects one of the input speech 18 or 20 for suppression over the other speech. For example, the speaker selector 86, based on a criteria, may select the input speech 20 for suppression over the input speech 18.

The speaker suppressor 88 then suppresses the input speech 20 in favor of not suppressing the input speech 18. The speaker suppressor 88 only suppresses the input speech 20 when the overlap is detected and not when the overlap is not detected. The resulting speech that is provided by the speaker suppressor 88 to the speech output unit 16 for output as the output speech 22 then only includes speech of one user at a time. The output speech 22 may then be fed back to the users so that both users know which speech has been selected and which speech has been suppressed by the speaker suppressor 88.

The delay trigger 98 determines whether a gap between time segments in the input speech 18 or 20 requires an injected utterance. The gap may for example be for a period of time that is predictable based on a known process that is carried out to convert the input speech 18 or 20. Such a known process may for example be accent conversion carried out by the accent converter 60.

Alternatively, the gap may be for a period of time that is determined by implementing a machine learning predictor using contextual features. Such contextual features may for example include network speed, jitter, bandwidth, or prior latencies in transmission.

The utterance selector 92 may select a type of utterance based on the same contextual features that caused the delay trigger 98 to determine that a gap between time segments in the input speech requires an injected utterance. The type of utterance selected by the utterance selector 92, based on the contextual features, may for example be a sound made by a human or a background sound. Contextual features that may determine the type of utterance may for example be turns in a conversation.

The utterance generator 90 generates utterances that are sent to the utterance selector 92. The utterance generator 90 may for example generate utterances based on recordings from a speaker, synthesized utterances of the speaker, recordings of background noise from the speaker, or an audio cue to suggest the incoming of an utterance.

FIG. 2 illustrates how the intelligibility improvement engine 54 may further be used to output speech at the speech generator 56 based on the listener profile 80 in the listener profile database 48. At 102, the listener profile of the particular listener is determined. At 104, a determination is made whether the listener is a senior citizen. A senior citizen may for example be someone who is over 70 years old. If the determination is made that the listener is a senior citizen then, at 106, several adjustments are made to the speech, including an increase in volume of the speech, a reduction in speed of the speech, and a reduction in a frequency of the speech. If, at 104, a determination is made that the listener is not a senior citizen then, at 108, the original audio is retained without making the adjustments as shown at 106. At 110, an output is provided of the audio.

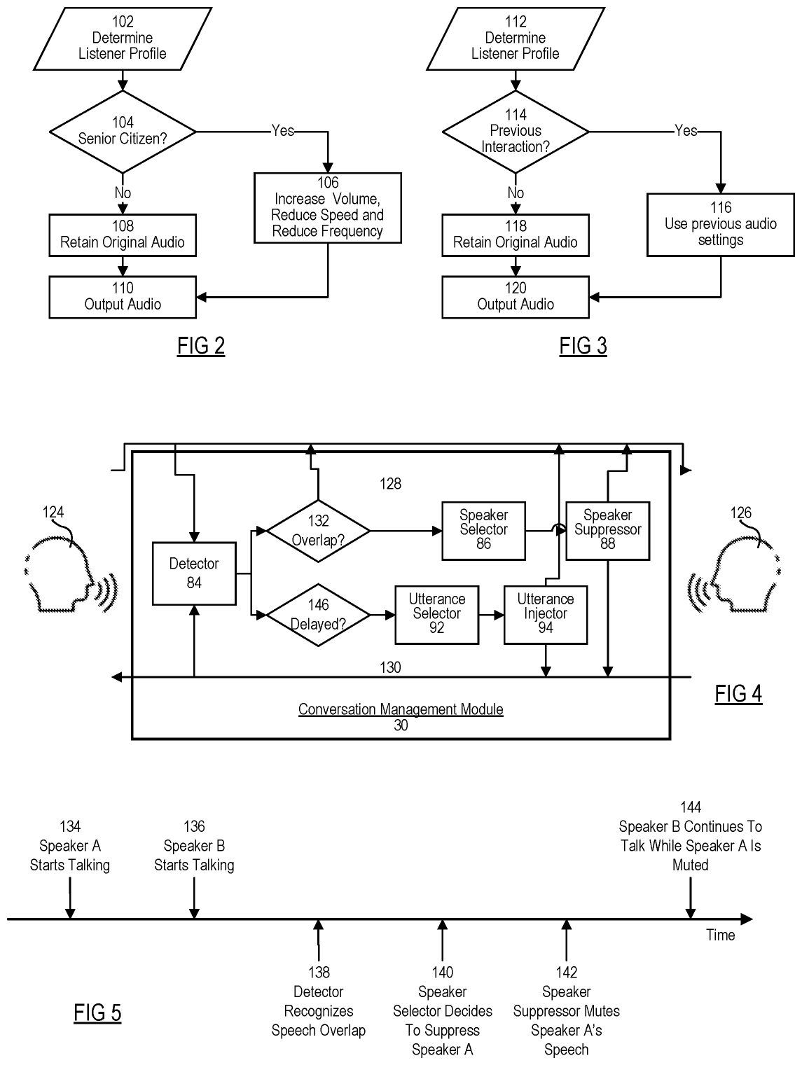

FIG. 3 illustrates a further example of how the intelligibility improvement engine 54 may be used to modify the speech based on a listener profile. At 112, a determination of the listener profile is made. At 114, a determination is made of whether there was a previous interaction with the listener. If an interaction was made with the listener, then, 116, the speech is adjusted to an audio setting that was previously selected by the listener. The listener may, for example, previously have selected a particular volume level. If no previous interaction is determined at 114, then, 118, the original audio is retained without the adjustments in 116. At 120, an output is provided of the audio.

There are numerous issues that reduce the intelligibility of speech. For example, there may be background noise; the speaker may be speaking too fast, or be too quiet; the speaker may have an accent; they may simply mispronounce certain words, make grammatical errors, or use expressions/idioms that are specific to one region; they may have speech impediments that prevent them from speaking clearly. All of these can make communication less effective.

The speech clarification module 26 together with speech modification module 28 improve the speech communication of people by reducing the background noise, adjusting the speaker's speed, volume, accent, pronunciation, regional specific expressions/idioms, and grammatical errors based on both a speaker and a listener's profile.

The speech clarification module 26 and the speech modification module 28 may be used in any communication settings that involve voice. Examples of the usage include remote communications (such as phone calls, video conferencing, walkie-talkie), in-person communication (such as hearing aid), broadcasting communications (such as playing radio, video recordings or streamings, or through speakers), etc.

There are a number of ways of implementing the components of the speech modification module 28. For example, the audio receptor 52 can be implemented to convert audio inputs into text representation, phoneme representation or a numeric representation (e.g., an embedding function).

In the given example, the intelligibility improvement engine 54 is implemented based on subcomponents working in a pipeline or jointly. They can work with the components of the intelligibility improvement engine 54 in a pipeline to remove the noise, convert accent, correct pronunciation, or grammatical mistakes, localize expressions/idioms and replace profanities with more acceptable expressions. The components of the intelligibility improvement engine 54 can also work in a joint fashion to find the best output that improves the intelligibility of the speech the most.

The accent conversion can be implemented based on text-to-speech conversion if the audio inputs are converted into text representation.

The accent conversion can also be implemented through a phoneme lookup dictionary if the audio inputs are converted into phoneme representation.

The accent conversion can also be implemented as a machine learning model that generates the representation for the target accent based on a numeric representation (e.g. an embedding).

The grammatical correction can be implemented based on natural language processing techniques if the intermediate representation is text based. Grammatical correction can also be implemented based on a deep learning algorithm if the intermediate representation is numeric based.

The grammatical correction can have a number of settings that adjust its behaviors. For example, it may have a confidence threshold so that it'd only adjust speech if it is highly confident that the input is wrong, and the adjustment will express the same semantics as the original input.

Examples of the grammar knowledge base include a rule based knowledge base such as a list of common grammatical swaps and their corresponding correct expressions (e.g., “many” for “much” in cases like “so much problems”). The knowledge base can also be based on a large language model that reflects the common language usage patterns.

The localization can be implemented based on phrase replacement by looking up in a dictionary if intermediate representation is text based.

Localization can alternatively be implemented using machine translation techniques to translate expressions specific to one region to expressions commonly used in another.

The pronunciation correction can be implemented based on natural language processing techniques if the intermediate representation is text based.

Pronunciation correction can use a rule based system to search for common patterns listed in the pronunciation knowledge base.

Pronunciation correction can use a language model to see if any mispronounced word is out of place in the given context. For example, seeing the word “fort” in the sentence “that is not my strong fort”, the engine can infer that “fort” is a mispronunciation of “forte”.

Similar techniques can also be used on phoneme based representations, such as “a kup of eks prae so” can be recognized as a mispronunciation of “a cup of espresso”.

Pronunciation correction can also be implemented based on a deep learning algorithm that learns to find patterns in the numeric representation of speech and recognizes common mispronunciations in the pronunciation knowledge base.

A number of settings may be used for adjusting behaviors in pronunciation correction. For example, a confidence threshold may be implemented so that pronunciation replacements are only carried out if there is a high confidence that the replacements will express the correct semantics of the original input.

For pronunciation correction, a list of commonly mispronounced words and their corresponding correct expressions may be used. Pronunciation correction can also be based on the phoneme of the mispronunciations and corrections. A large language model that reflects the common language usage patterns may be based on a large language model that reflects the common language usage patterns. Another option to implement it is through machine translation techniques that can take into consideration of the context so that not every occurrence of a word/expression is replaced (e.g., replace the word “the breeze” in the context of a disaster aftermath but not in the context of the description of a mild weather).

The speech generator 56 can be implemented in a number of ways. For example, the speech generator 56 can be a text-to-speech system if the intermediate representation is text based. the speech generator 56 can also be a speech generator based on numerical based intermediate representation. Additionally, the speech generator 56 can include additional components to ensure the output audio matches with the original speaker's voice, speech and prosody or those of a different speaker.

The configurator 50 utilizes a speaker profile to select the most appropriate models. Such a speaker profile can be stored in a database, or be detected automatically or adjusted dynamically in real time. For example, for a British speaker, the configurator 50 can detect the accent, select the appropriate accent conversion model and localization model for British English. The configurator 50 may even analyze the speaker to produce a gradient weight that can be used to compose the different accent/localization models' outputs to accommodate an accent that is influenced by more than one region.

The configurator 50 utilizes a listener profile to adjust the parameters of other components. Such a listening profile can be stored in a database, or be detected automatically or adjusted dynamically in real time. For example, for a senior citizen listener, the configurator 50 can set the speech generator 56 to produce audio at a slower speed and higher volume. As another example, for a listener with a slower internet connection, the configurator 50 may skip some components or use a faster model to reduce the latency introduced by the slow connection. As another example, the configurator 50 may adjust the parameters based on the listener's response. If a listener constantly asks the speaker to repeat himself, the configurator 50 may adjust the parameters to ensure that the best level of intelligibility is achieved. As another example, the configurator 50 may use the saved profile of a listener to restore the parameters that work the best for the listener.

The speech modification module 28 can produce the output speech in real time with minimum latency from the input speech by adopting a fast processing audio receptor, verifier and generator. A latency less than 350 milliseconds has minimum disruption on the listening experience when communicating digitally over distances or 20 milliseconds when communicating in person.

The speech modification module 28 can also be used in offline mode if the real time requirement is not needed. Additionally, the speech modification module 28 may be used in an interactive mode with a human in the loop to approve system suggested replacements.

The speech modification module 28 can be deployed in a number of ways. For example, the speech modification module 28 can be implemented on-device, such as in a specialized audio aid device or a general purpose computer whose audio driver can redirect audio inputs to the invention and redirect the invention's output to regular audio outputs. Another example, the speech modification module 28 can be implemented as a cloud based service with a client, such as an audio driver, that redirects audio inputs to the invention's cloud service and downloads the invention's output.

FIG. 4 illustrates in more detail the functioning of the conversation management module 30 in FIG. 1 between a first user 124 and a second user 126. Speech travels from the first user 124 to the second user 126 along a first channel 128 and from the second user 126 to the first user 124 along a second channel 130.

The detector 84 is connected between the channels 128 and 130. At 132, the detector 84 determines whether there is an overlap between the speech in the channels 128 and 130. The speaker selector 86 then selects one of the speakers and the speaker suppressor 88 suppresses the speech of the other speaker. For example, the speaker selector 86 may select the speech from the first user 124 on the first channel 128, in which case the speaker suppressor 88 suppressed the speech from the second user 126 on the second channel 136.

FIG. 5 illustrates an example of how the speaker selector 86 and speaker suppressor 88 may function. At 134, Speaker A starts talking, for example, the first user 124 in FIG. 4. At 136, Speaker B starts talking, for example, the second user 126 in FIG. 4. At 138, the detector 84 recognizes that there is an overlap in the speech. At 140, the speaker selector 86 decides to suppress Speaker A. At 142, the speaker suppressor 88 mutes Speaker A's speech. At 144, speaker B continues to talk while Speaker A is muted.

During a phone conversation, people often talk over each other resulting in neither person being heard clearly. This could be due to a number of reasons: for example, people may happen to speak at the same time; or the listener interrupts the speaker but because of audio transmission/processing delays the speaker does not stop speaking quickly enough and appears to not respect the interruption by the listener; or a variable latency in audio transmission/processing causes the listener to believe that the speaker has finished talking and the listener starts talking while additional speech is still being transmitted.

The overlapping speech frustrates both sides of the conversation, and results in ineffective communication. This is especially true in a business environment that requires the customer to be heard.

The detector 84 recognizes that multiple people are speaking at the same time. This can be implemented in a number of ways. For example, it can detect the speech overlap by the detection of overlapping voice activities in each speaker's channel.

The detector 84 can run on a device used by either speaker or run in the cloud between the speakers.

The speaker selector 86 decides which speaker to mute. This can be done by predetermined rules. For example, in a customer service or sales setting, the speaker selector 86 can always choose the customer service or sales agent, or virtual agent, to mute for a better customer experience. As another example, the speaker selector 86 can allow the one who starts speaking first to continue and mute the other speaker to give everyone a fair chance to talk.

The speaker suppressor 88 turns off a speaker's audio so that the listener will not hear the speaker. This can be implemented as a simple switch that turns off or softens the audio of the speaker's channel.

The conversation management module 30 can be installed on a device used by the speaker, on a device used by the listener, or on a server in the cloud.

Referring again to FIG. 4, at 146, the detector 84 determines whether there is a delay that requires an utterance to be injected. The detector 84 may detect a gap in either the channel 128 or the channel 130. The utterance selector 94 then selects an utterance for injection and the utterance injector 94 injects the utterance into the appropriate channel 128 or 130.

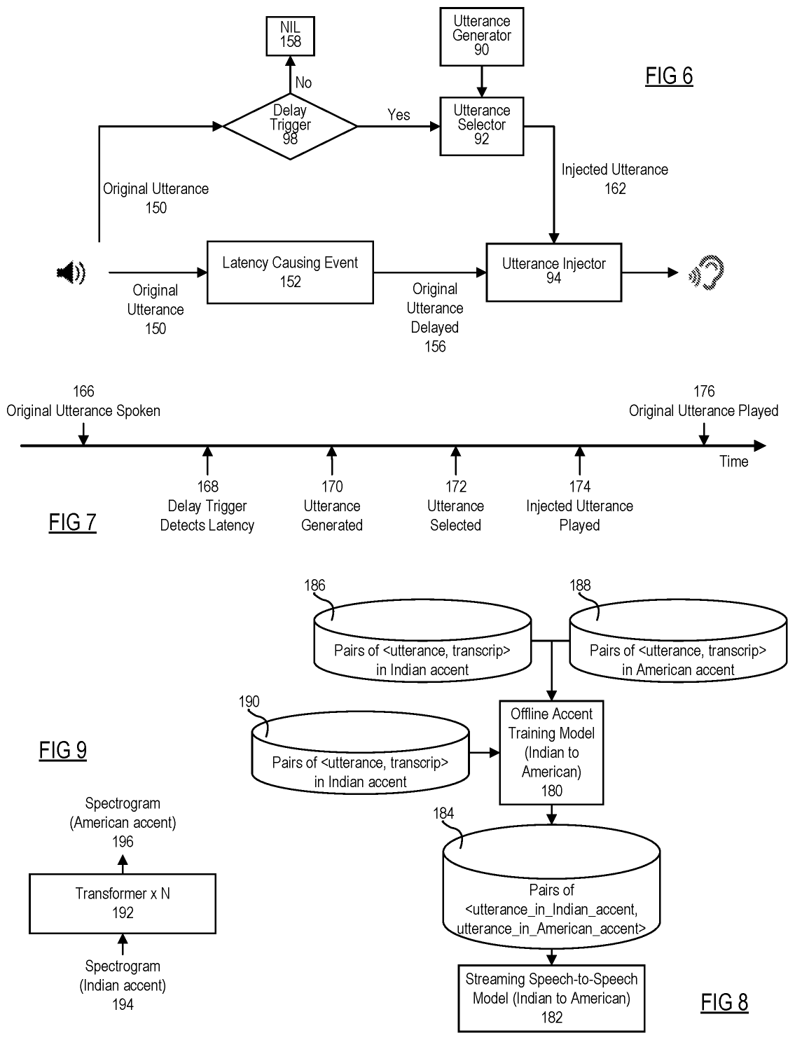

FIG. 6 illustrates another way that the utterance injection process may be illustrated. An original utterance 150 is created by one of the speakers, for example the first user 124 on the first channel 128. The original utterance may be delayed by a latency causing event 152 resulting in the original utterance being delayed at 156. The original utterance 150 is also detected by the delay trigger 98. If the delay trigger 98 does not detect a latency causing event, then no further action is taken to inject an utterance, represented by NIL158. If a delay is detected, then the utterance selector 92 retrieves an utterance from the utterance generator 90 and passes the utterance as an injected utterance 162 on to the utterance injector 94. The utterance injector 94 then injects the injected utterance 162 into the delayed original utterance 156.

FIG. 7 illustrates one way that the utterance can be injected. At 166, the original utterance 150 is spoken. At 168, the delay trigger 98 detects a latency. At 170, the utterance generator 90 generates an utterance. At 172, the utterance selector 92 selects an utterance generated by the utterance generator 90. At 174, the injected utterance 162 is played. At 176, the original utterance 150 is played.

Injected utterances 162 can smooth out speech in real time. In audio transmissions, there are a number of causes that result in choppy speech, i.e., noticeable and unexpected pauses in speech which reduce the fluency of utterances. Causes of choppy speech is network latency. Another cause is artificial intelligence speech enhancements (such as voice conversion or accent conversion). Such enhancements may take longer than expected, resulting in latency causing events to complete, which cause the wait time between utterances to be longer than expected. The choppy or delayed speech may result in the listener starting to speak, to check if the speaker is still there, before the speaker's utterance has a chance to be transmitted, causing the flow of the conversation to be interrupted.

Injecting audio (e.g., disfluencies like “umm” or “hmm”, and background noises like keyboard clicks) into speech can alleviate the choppiness and pauses in speech caused by latency. The injected audio provides acoustic clues to the listener that additional speech is being transmitted, which helps avoid extraneous interruptions by listeners who might otherwise inquire about such delays. In other words, this reduces the chance that the listener would start talking before the speaker has a chance to respond, helping avoid a breakdown in communication.

Injected audio can be used for communication between humans and communication between an automated system and a human.

The delay trigger 98 determines if an injection is needed. For latency that is more predictable and deterministic, such as Artificial Intelligence (“AI”) speech enhancement components, the trigger can be implemented based on a set of rules. For example, if an accent conversion component is used, it may predictably take 500 ms to convert an input which causes an extra 500 ms latency. The trigger will fire whenever the accent conversion component is used.

For latency that is more unpredictable, the trigger can be implemented as a machine learning based predictor using contextual features, such as the network speed, jitter, bandwidth, and prior latencies in transmission. For example, the predictor can determine that the likelihood of the network being slow is above a threshold during certain times of the day, and this causes the trigger to fire.

The utterance selector 92 determines the type of utterances or sounds to be injected into the original speech based on contextual clues. For example, if in the previous turn, the listener expressed positive sentiment, the utterance (or sound) selected is likely to be confirmatory or positive. If in the previous turn, the listener expressed negative sentiment, then the utterance (or sound) selected is more likely to be supportive or sympathetic.

The utterance selector 92 can also pick neutral utterances/sounds, like disfluencies (e.g., “umm”, “ahhh”, “hmm”, throat clearing), or background sounds (e.g. keyboard clicks, melody/jingle, other people, etc)”

The utterance selector 92 can be implemented using rules or machine learning models using features such as sentiment analysis on the previous turn. For example, it may have rules such that first the utterance/sound selected is a melody/jingle, followed by a pattern of “um”, “ahhh” and throat clearing.

Another way to implement the utterance selector 92 is to use machine learning to learn which utterance to use based on the turns of the conversation. It may learn that background sounds are best to use after the listener's initial greeting, and a positive disfluency such as “yep” is best near the end of the call.

The utterance generator 90 generates candidate short utterances or sounds that are sent to the selector. The utterance generator 90 could generate utterances based on a number of ways such as:

Synthesized utterances of the speaker (e.g., text-to-speech synthesis, voice conversion, accent conversion, sound synthesis, etc).

An audio cue to suggest the incoming of an utterance (e.g., melody/jingle).

The utterance injector 94 combines the injected utterances/sound with the original utterance so that there is no overlap between them. The utterance injector 94 plays the injected utterance/sound first while waiting for the original utterance. If the injected utterance/sound has not finished, but the original utterance has arrived, the merger would hold off the original utterance until the injected utterance finishes transmitting to the listener.

The system can be installed on a device used by the speaker, on a device used by the listener, or on a server in the cloud. Certain components can be installed on the speaker or listener device (e.g., delay trigger 98, utterance generator 90, utterance selector 92), and other components on the server (e.g., Latency Causing Event 152).

FIG. 8 illustrates further details of the accent conversion model 62 in FIG. 1, including an offline accent training model 180 and a streaming speech-to-speech model 182. The offline accent training model 180 generates a conversion relationship 184 between a first accent, in the example an Indian accent, of the language, in the present example English, to a second accent, in the present example American, of the language. The streaming speech-to-speech model 182 converts from the India accent of English to the American accent of English based on the conversion relationship 184. The accent conversion model 62 has a first training structure 186, a second training structure 188, and an input structure 190. The first training structure 186 includes pairs of utterances and transcripts in the Indian accent. The second training structure 188 includes pairs of utterances and transcripts in the American accent. The input structure 190 includes pairs of utterances and transcripts in the Indian accent. The offline accent training model 180 trains on the first training structure 186 and the second training structure 188 based on input from the input structure 190 to develop inferences to generate the conversion relationship 184. The conversion relationship 184 includes pairs of utterances in the Indian accent and utterances in the American accent.

FIG. 9 shows further details of the streaming speech-to-speech model 182. The streaming speech-to-speech model 182 includes a plurality of transformers 192. Each transformer 192 converts a spectrogram 194 of the Indian accent to a spectrogram 196 of the American accent. The transformers 192 all have different parameters for execution. The transformers 192 function in series so that an output of one transformer is fed into an input of the next transformer.

One of the transformers 192 are an example of a neural network model and is preferred because of its power. Long Short-Term Memory (LSTM) is a neural network model that provides more tunability. Other neural network model may also be used, for example a neural transducer.

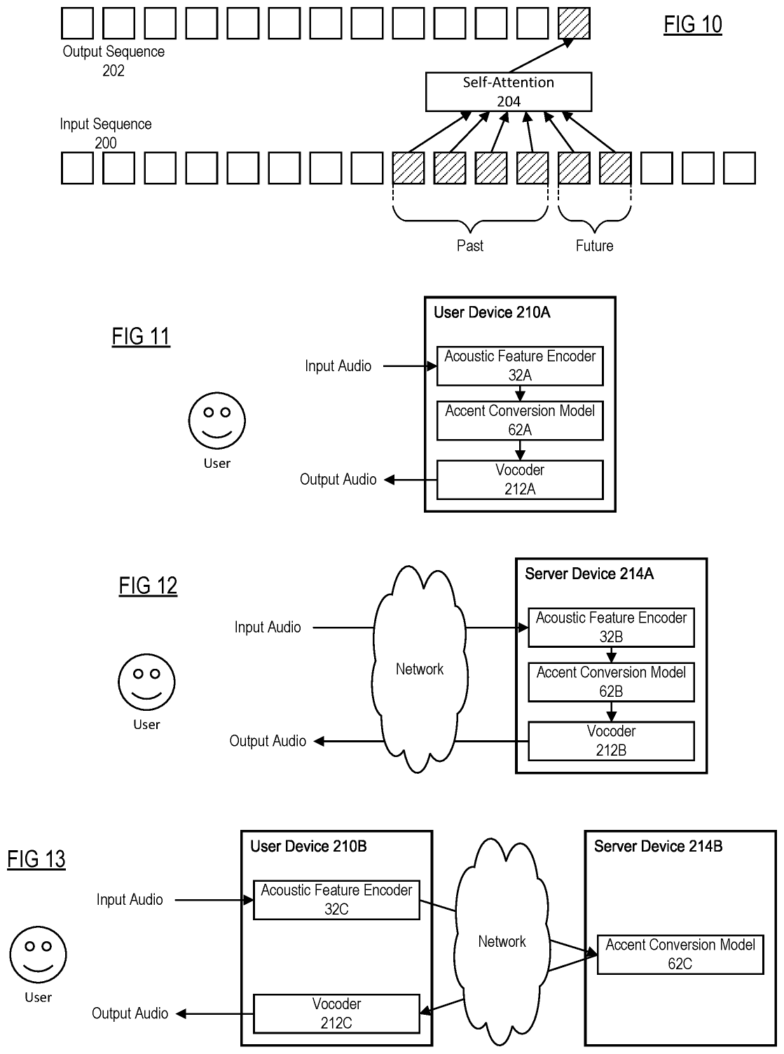

FIG. 10 shows an input sequence 200 and an output sequence 202 of one of the transformers 192. The transformer 192 uses self-attention 204 to model a sequence of input elements of the input sequence 200 and a sequence of output elements of the output sequence by tracking relationships of the input elements. Specifically, for each output element the self-attention 204 looks at a subset of past input elements and a subset of future input elements.

Speaking in different accents or dialects often is a communication barrier even when people are speaking the same language. Such a barrier can make communication prohibitive, or difficult, or less efficient. Converting or softening the accents or dialects can be greatly beneficial to communication efficiency in such situations. For remote communication over phone calls or video calls, the communication efficiency can be further improved by enhancing the speech signals (such as removing background noise, normalizing the volume, etc.), which can happen at the same time as the accent conversion.

On the other hand, in certain situations, speaking in certain non-standard accents or dialects can be desired, such as for entertainment purposes. However, the speakers may not be able to speak in such accents or dialects. Having a system to automatically convert the accent or dialect can make it possible.

The accent conversion model 62 illustrated in FIGS. 1, 8, 9 and 10 provides real-time speech-to-speech accent conversion, without the need for intermediary text conversion. The accent conversion model 62 can receive an input audio signal of a speaker's voice with a specific accent, then generate an output audio signal with a target accent (or close to a target accent) while preserving the speaker's original speech content and characteristics (e.g., voice, emotion, prosody). The accent conversion model 62 can optionally further enhance the audio signal by removing background noise, normalizing the volume, etc.

The accent conversion model 62 can potentially be used in call centers, video meetings, games, audio, and video content creation and editing, etc.

The are two approaches when it comes to machine learning models for accent conversion:

A first approach involves conversion to a compact speech representation.

The compact speech representation can be signal processing-based, such as mel-spectrogram, MFCC, which are popularly used in text-to-speech synthesis and automatic speech recognition systems. The compact speech representation can also be machine learning-based, notably as discrete representation, such as from Van Den Oord, Aaron, and Oriol Vinyals. “Neural discrete representation learning.” Advances in neural information processing systems 30 (2017); Hsu, Wei-Ning, et al. “Hubert: Self-supervised speech representation learning by masked prediction of hidden units.” IEEE/ACM Transactions on Audio, Speech, and Language Processing 29 (2021): 3451-3460; Zeghidour, Neil, et al. “Soundstream: An end-to-end neural audio codec.” IEEE/ACM Transactions on Audio, Speech, and Language Processing 30 (2021): 495-507; Defossez, Alexandre, et al. “High fidelity neural audio compression.” arXiv preprint arXiv:2210.13438 (2022), etc.

There are two components that work together to achieve accent conversion:

A machine learning-based accent conversion model takes speech representation of the original audio as input, and generates the compact speech representation corresponding to the target accent. Such a model can be a lightweight causal neural network, e.g., Recurrent Neural Network (RNN), LSTM, Convolution network, Transformer, neural transducer, etc., that can infer in a streaming manner in real-time.

A machine learning-based or signal processing-based vocoder model converts the target speech representation into waveforms.

The advantage of using such a compact speech representation is that it makes the conversion model easier to train. In addition, in a network-based deployment, it can potentially reduce network traffic and therefore latency compared to transmitting audio signals.

The second approach for accent conversion involves conversion to a wave form directly.

A machine learning-based model may be used for directly converting the input speech representation into waveforms in the target accent. Such a model can be a lightweight causal neural network, e.g., RNN, LSTM, Convolution network, Transformer, neural transducer, etc., that can infer in a streaming manner in real-time.

Compared to using an intermediary compact speech representation, this approach has the potential advantages of lower latency and less computational resource consumption.

When trained properly, the accent conversion model can be able to preserve the speaker's identity (voice) and the emotion and prosody of the source speech, when converting it into a different accent. See Jia, Ye, et al. “Direct speech-to-speech translation with a sequence-to-sequence model.” Interspeech (2019); and Jia, Ye, et al. “Translatotron 2: High-quality direct speech-to-speech translation with voice preservation.” International Conference on Machine Learning. PMLR, 2022.

Such additional preservation can make the communication more natural and smoother, and may be achieved without extra computational or latency cost at inference time.

If the accent conversion model is trained with proper training data, or when adopting proper data augmentation, e.g., mixing extra noise on the input, the trained accent conversion model can be capable of further clarifying the speech with extra enhancement, such as noise reduction, while it converts accents.

Such additional speech enhancement can further improve the communication efficiency, and may be achieved without extra computational or latency cost at inference time.

FIG. 11 illustrates on-device deployment of accent conversion. A user device 210A includes on-device deployment of accent conversion. The user device 210A includes an acoustic feature encoder 32A, an accent conversion model 62A, and a vocoder 212A.

The user device 210A may be a smartphone, a desktop computer, a smart watch, etc. Such a deployment benefits from lower latency and safety on data privacy and security, but would require the device to have sufficient computing power for the model inference.

FIG. 12 illustrates on-server deployment of accent conversion. A server device 214A includes an acoustic feature encoder 32B, an accent conversion model 62B, and a vocoder 212B.

On-server deployment benefits from more powerful computational resources on the server, and easier production release and version management. It has the drawback of extra network latency for scenarios sensitive to latency.

FIG. 13 illustrates server-client mixed deployment of accent conversion. A user device 210B includes an acoustic feature encoder 32C, and a vocoder 212C. A server device 214B includes an accent conversion model 62C. By deploying the encoder and vocoder components on-device, such a deployment transits the compact speech representation over the network instead of the raw audio signals, which can significantly save the network data traffic amount therefore reduce the overall latency.

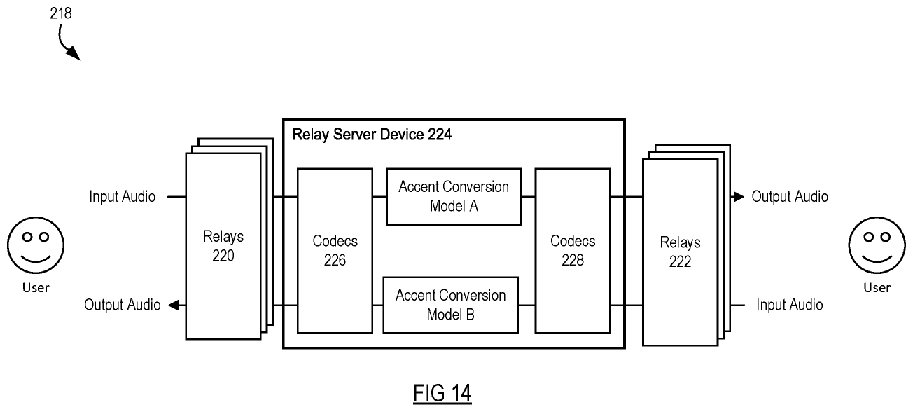

FIG. 14 illustrates relay deployment of accent conversion. A telephone system 218 includes first and second stacks of relays 220 and 222, respectively. A relay server forms a further layer within the telephone system 218. The relay server device 224 is positioned between the stacks of relays 220 and 222.

The relay server device 224 includes an accent conversion model A, an accent conversion model B, and first and second codecs 226 and 228. A channel is formed by a connection respectively by the relays 220, codecs 226, accent conversion model A, codecs 228 and relays 222. The accent conversion model A may convert for example an Indian accent to an American accent, both in English. A further channel is formed by connections between the relays 222, codecs 228, accent conversion model B, codecs 226, and relays 220. The accent conversion model B may, for example, convert an American accent to and English accent, both in English.

While the relay setup is also a server-based approach, compared to the on-server deployment described above, this deployment avoids transmitting the output audio (or compact speech representation) back to the user's device, and therefore reduces the network latency. The relay setup may for example be deployed as a session initiated protocol (SIP) based proxy with telephony packets that may traverse a networks firewall.

Compared to accent conversion using intermediary text presentation, which is typically comprised as speech recognition and then speech synthesis, direct speech-to-speech accent conversion has the advantage of: 1) better content fidelity during the convention, by avoiding speech recognition errors; 2) easier to preserve speaker identity and speech emotion and prosody, which leads to more natural and smooth communication and better user experience; 3) lower latency and computational cost.

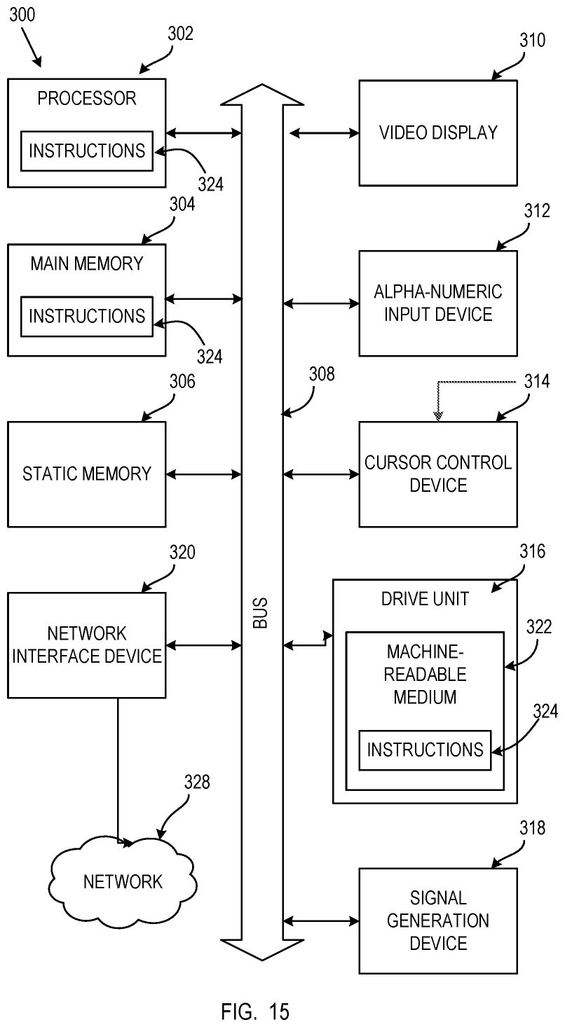

FIG. 15 shows a diagrammatic representation of a machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 (e.g., read only memory (ROM), flash memory, dynamic random access memory (DRAM) such as synchronous DRAM (SDRAM) or Rambus DRAM (RDRAM), etc.), and a static memory 306 (e.g., flash memory, static random access memory (SRAM), etc.), which communicate with each other via a bus 308.

The computer system 300 may further include a video display 310 (e.g., a liquid crystal display (LCD) or a cathode ray tube (CRT)). The computer system 300 also includes an alpha-numeric input device 312 (e.g., a keyboard), a cursor control device 314 (e.g., a mouse), a disk drive unit 316, a signal generation device 318 (e.g., a speaker), and a network interface device 320.

The disk drive unit 316 includes a machine-readable medium 322 on which is stored one or more sets of instructions 324 (e.g., software) embodying any one or more of the methodologies or functions described herein. The software may also reside, completely or at least partially, within the main memory 304 and/or within the processor 302 during execution thereof by the computer system 300, the main memory 304 and the processor 302 also constituting machine-readable media.

The software may further be transmitted or received over a network 328 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A communication system comprising:
a processor;
a computer-readable medium connected to the processor; and
a set of instructions on the computer-readable medium, including:
a speech reception unit executable by the processor to receive input speech in the form of an input signal derived from a sound wave generated by a microphone that includes input language;
a speech processing system connected to the speech reception unit and executable by the processor to modify the input signal to an output signal wherein the input speech in the input signal is modified to output speech in the output signal, wherein the speech processing system includes:
a speech modification module executable by the processor to modify the input language in the input signal, wherein the speech modification module includes:
an intelligibility improvement engine having:
an accent conversion model; and
an accent converter that modifies an accent in the input language based on the accent conversion model; and
a speech output unit connected to the speech processing system and executable by the processor to provide an output of the output signal.

2. The system of claim 1, wherein the accent converter retains a voice of the input speech.

3. The system of claim 1, wherein the accent converter retains prosody of the input speech.

4. The system of claim 1, wherein the accent conversion model includes:
an offline training model that generates a conversion relationship between a first accent of the language to a second accent of the language; and
a streaming speech-to-speech model that converts from the first accent of the language to the second accent of the language based on the conversion relationship.

5. The system of claim 4, wherein the accent conversion model has:
a first training structure of pairs of utterances and transcripts in the first accent;
a second training structure of pairs of utterances and transcripts in the second accent; and
an input structure of pairs of utterances and transcripts in the first accent,
wherein the offline training model trains on the first training structure and the second training structure based on input from the input structure to develop inferences to generate the conversion relationship.

6. The system of claim 5, wherein the streaming speech-to-speech model has:
at least one neural network model to convert a spectrogram of the first accent to a spectrogram of the second accent.

7. The system of claim 6, wherein the streaming speech-to-speech model has:
a plurality of neural network models to convert a spectrogram of the first accent to a spectrogram of the second accent.

8. The system of claim 7, wherein the neural network models have different parameters for execution.

9. The system of claim 7, wherein the neural network models function in series.

10. The system of claim 6, wherein the at least one neural network model uses self-attention to model a sequence of input elements and a sequence of output elements by tracking relationships between pairs of the input elements.

11. The system of claim 10, wherein, for each output element, the self-attention looks at a subset of past input elements and a subset of future input elements.

12. The system of claim 1, further comprising:
a relay server device positioned between first and second stacks of relays in a telephone system, the accent conversion model forming part of the relay server device.

13. The system of claim 12, wherein the relay server device includes first and second codecs that connect the accent conversion device to the first and second stacks of relays respectively.

14. The system of claim 13, wherein the accent conversion model is a first accent conversion model, further comprising:
a second accent conversion model that converts the second accent to the first accent, the second accent conversion model being connected to the first and second stacks of relays by the first and second codecs respectively.

15. The system of claim 1, wherein the intelligibility improvement engine has:
at least a first knowledge base; and
at least a first routine that modifies the input language based on the first knowledge base.

16. The system of claim 1, wherein the speech processing system includes:
a conversation management module having:
an overlap trigger to detect an overlap of input speech from first and second input signals; and
a speaker suppressor connected to the overlap trigger to suppress the second speech in favor of not suppressing the first speech only when the overlap is detected and not when the overlap is not detected.

17. The system of claim 1, wherein the speech processing system includes:
a conversation management module executable by the processor and having:
a delay trigger that determines whether a gap between time segments in the input speech requires an injected utterance; and
an utterance injector that merges an utterance with the time segments so that the utterance is between the time segments in the output speech.

18. A method of communicating comprising:
executing by a processor a speech reception unit to receive input speech in the form of an input signal derived from a sound wave generated by a microphone that includes input language;
executing by the processor a speech processing system connected to the speech reception unit to modify the input signal to an output signal wherein the input speech in the input signal is modified to output speech in the output signal;
executing by the processor a speech modification module to modify the input language in the input signal, wherein the speech modification module includes:
an intelligibility improvement engine having:
an accent conversion model; and
an accent converter that modifies an accent in the input language based on the accent conversion model; and
executing by the processor a speech output unit connected to the speech processing system to provide an output of the output signal.

19. The method of claim 18, wherein the accent converter retains a voice of the input speech.

20. The method of claim 18, wherein the accent converter retains prosody of the input speech.

21. The method of claim 18, wherein the accent conversion model includes:
an offline training model that generates a conversion relationship between a first accent of the language to a second accent of the language; and
a streaming speech-to-speech model that converts from the first accent of the language to the second accent of the language based on the conversion relationship.

22. The method of claim 21, wherein the accent conversion model has:
a first training structure of pairs of utterances and transcripts in the first accent;
a second training structure of pairs of utterances and transcripts in the second accent; and
an input structure of pairs of utterances and transcripts in the first accent, wherein the offline training model trains on the first training structure and the second training structure based on input from the input structure to develop inferences to generate the conversion relationship.

23. The method of claim 22, wherein the streaming speech-to-speech model has:
at least one neural network model to convert a spectrogram of the first accent to a spectrogram of the second accent.

24. The method of claim 23, wherein the streaming speech-to-speech model has:
a plurality of neural network models to convert a spectrogram of the first accent to a spectrogram of the second accent.

25. The method of claim 24, wherein the neural network models have different parameters for execution.

26. The method of claim 24, wherein the neural network models function in series.

27. The method of claim 23, wherein the at least one neural network model uses self-attention to model a sequence of input elements and a sequence of output elements by tracking relationships between pairs of the input elements.

28. The method of claim 27, wherein, for each output element, the self-attention looks at a subset of past input elements and a subset of future input elements.

29. The method of claim 18, further comprising:
a relay server device positioned between first and second stacks of relays in a telephone system, the accent conversion model forming part of the relay server device.

30. The method of claim 29, wherein the relay server device includes first and second codecs that connect the accent conversion device to the first and second stacks of relays respectively.

31. The method of claim 30, wherein the accent conversion model is a first accent conversion model, further comprising:
a second accent conversion model that converts the second accent to the first accent, the second accent conversion model being connected to the first and second stacks of relays by the first and second codecs respectively.

32. The method of claim 18, wherein the intelligibility improvement engine has:
at least a first knowledge base; and
at least a first routine that modifies the input language based on the first knowledge base.

33. The method of claim 18, wherein executing the speech processing system includes:
executing a conversation management module executable by the processor and having:
an overlap trigger to detect an overlap of input speech from first and second input signals; and
a speaker suppressor connected to the overlap trigger to suppress the second speech in favor of not suppressing the first speech only when the overlap is detected and not when the overlap is not detected.

34. The method of claim 18, wherein executing the speech processing system includes:
executing a conversation management module executable by the processor and having:
a delay trigger that determines whether a gap between time segments in the input speech requires an injected utterance; and
an utterance injector that merges an utterance with the time segments so that the utterance is between the time segments in the output speech.

35-122. (canceled)
